(19) United States
(12) Patent Application Publication
(10) Pub. No.: US 2009/0309974 A1
(43) Pub. Date: Dec. 17, 2009

(54) Electronic Surveillance Network System

(76) Inventors: Shreekant Agrawal, Rancho Santa Margarita, CA (US); Ashish Derhgawen, Bangalore (IN)

Correspondence Address: Shreekant Agrawal, 14 Calle Serra, Rancho Santa Margarita, CA, 92688, US

(21) Appl. No.: 12/469,742

(22) Filed: May 21, 2009

Related U.S. Application Data
(60) Provisional application No. 61/128,811, filed on May 22, 2008.

(51) Int. Cl. H04N 7/18; G06F 15/16; G06F 17/30

(52) U.S. Cl. 348/159; 709/201; 707/104.1; 348/E07.085; 707/E17.044

(57) ABSTRACT

We have defined an automated detection system consisting of a combined visible and Short Wave Infra-Red (SWIR) camera that identifies vehicle identification number and the number of occupants in a given vehicle, as well as the speed of the automobile. This information is processed in conjunction with law enforcement rules to determine whether the particular vehicle driver is in violation to enable the law enforcement personnel to issue traffic violation ticket and mail it to the registered driver's address. Such an automated system could be placed at strategic locations along the stretch of the High Occupancy Vehicle (HOV) or carpool lanes and interconnected with backend computing and decision support system to assist law enforcement personnel in identifying vehicle driver violating the HOV or carpool lane rules and in issuing violation tickets to the registered driver of the particular vehicle.

### BACKGROUND OF THE INVENTION

Mobile computing solutions allow law enforcement to access information associated with driver and vehicle effectively, efficiently and securely in a ubiquitous and timely manner. These solutions have been purported to help improve law enforcement personnel's productivity and efficiency. Law enforcement has increased emphasis on automated detection of traffic infractions such as driving through red lights. In these cases automated systems have relied on visual cameras that are coordinated with traffic lighting system and road proximity sensors to detect the location of the given vehicle when traffic lights turn red. The automated system automatically detects vehicles driving through red light and snaps a flash assisted visual image of the vehicle for processing by law enforcement for issuing traffic violation tickets and mailing them to the address of the registered vehicle owner. The flash assisted visual image allows for law enforcement to determine the vehicle plate number during day and night. The success of the automated detection of driving through red lights has allowed the law enforcement departments to realize additional revenue stream that can be used for better community enrichment programs and more importantly allow the law enforcement personnel to focus on the more important areas where their physical presence is needed to ensure maintenance of law and order and assist the community.

The growth in population and the number of vehicles has outstripped the increase in the transportation infrastructure in terms of roads. Furthermore, cities have enlarged with the development of satellite cities around the core city. While housing communities have expanded in the suburbs, places of work and entertainment have been localized to areas within and close to the core city. Such expansion in housing communities with the concentration of places of work and entertainment has resulted in traffic patterns that have further increased the traffic demand and thereby congestion. Increased traffic congestion is very evident during peak usage hours on key roads that lead into and out of the city core or the main arterial roads connecting the satellite cities and the core city. In order to ameliorate this growing traffic congestion, cities have instituted high occupancy vehicle (HOV) lanes or carpool lanes within the roads that lead into and out of the city core or main arterial roads. The motivation behind this is to reduce the number of vehicles with single occupant. While this has resulted in improving the situation, the desire for vehicle drivers to adopt approaches such as carpooling to avail the privilege of driving on HOV lanes has not increased significantly. The net result of this lag in adoption of the multi-occupant commute is that the HOV lanes are not utilized to their capacity. So, a single-occupant vehicle driver has to endure the traffic congestion while observing the significantly underutilized HOV or carpool lane. This has resulted in vehicle drivers to break the rules and drive on the HOV lane in violation of the number of occupants required to drive on the HOV lanes. Since the number and length of HOV lanes is large it is impractical for law enforcement personnel to monitor it along the entire stretch of the HOV lanes. Therefore, vehicle drivers who break the rules are not effectively being apprehended by law enforcement personnel. In order to resolve this situation, there is a need for an automated system that can detect the number of occupants within a vehicle on the HOV lane at strategic points and enable traffic violation tickets to be issued. The traffic violation tickets can then be mailed to the registered driver of the vehicle. This approach will greatly increase the effectiveness of law enforcement and also increase the revenue generation potential.

### DESCRIPTION OF THE INVENTION

We have defined an automated detection system that identifies vehicle identification number and the number of occupants in a given vehicle, as well as the speed of the automobile. This information is processed in conjunction with law enforcement rules to determine whether the particular vehicle driver is in violation to enable the law enforcement personnel to issue traffic violation ticket and mail it to the registered driver's address. Such an automated system could be placed at strategic locations along the stretch of the HOV or carpool lanes and interconnected with backend computing and decision support system to assist law enforcement personnel in identifying vehicle driver violating the HOV or carpool lane rules and in issuing violation tickets to the registered driver of the particular vehicle.

In order for the automated detection system to function effectively the following functional and operational requirements have been assumed for the design and implementation of the automated detection system for vehicle drivers violating the HOV lane rules:
1. Law enforcement personnel have control over the infrastructure to enable deployment of detection system, where appropriate, at strategic locations
2. Detection is operational at vehicle speeds up to 120 mph
3. Detection system is capable of functioning with vehicles with both clear and tinted windows
4. Vehicle identification, i.e., number plates, are located at well-known areas on the vehicle to enable integration of commercially available off-the-shelf Automatic License Plate Recognition (ALPR) systems, e.g., http://www.platerecognition.info/ and http://www.platescan.com/
5. Approaching vehicles can be detected in the order of 100 to 300 feet range
6. Detection system enable visible and infrared imaging to ensure day and night operation
   a. Visible imaging includes normal visible and image intensification (I2) functionality that can be invoked based on the environmental conditions for complementary operation under high and low-lighted conditions
   b. Infrared imaging includes thermal and shortwave infrared (SWIR) imaging functionality for complementary operation, e.g., SWIR detectors can view objects not capable of being detected by thermal imaging, such as see-through glass

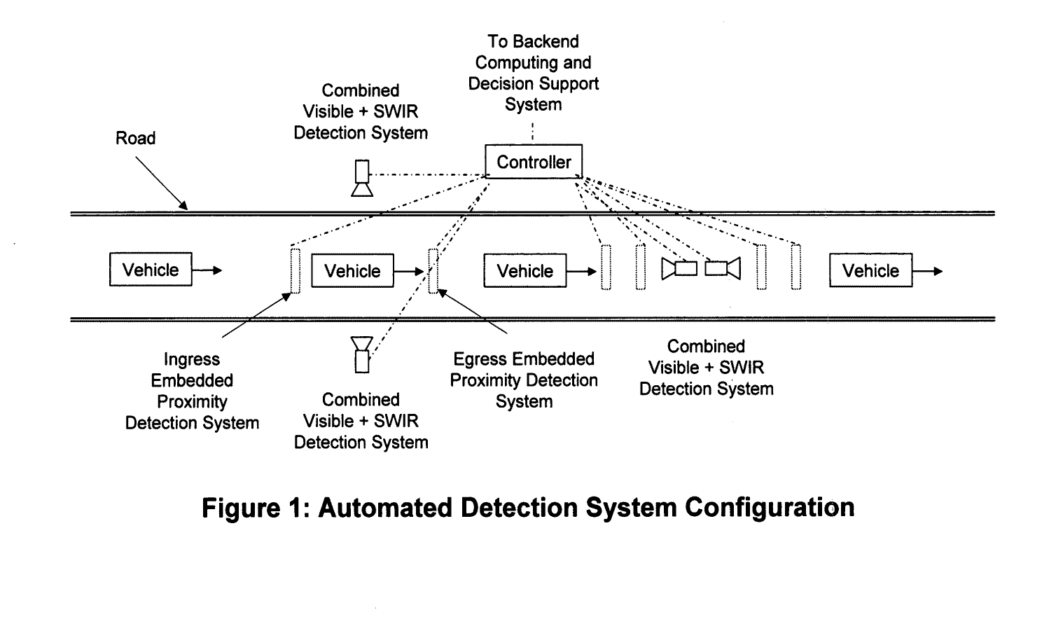

FIG. 1 illustrates a deployment instantiation of an automated detection system. The system consists of combined visible and SWIR detection system located perpendicular and at opposite sides of the road and pointing towards the road to enable the vehicle to be viewed from both its sides. The combined visible and SWIR detection system consists of a commercial off-the-shelf (COTS) indium gallium arsenide (InGaAs) video camera featuring high-sensitivity and wide dynamic range that provides real-time night-glow to daylight imaging in the SWIR wavelength spectrum for passive surveillance. The camera delivers clear video at every lighting level from partial starlight to direct sunlight due to on-board Automatic Gain Control (AGC), image enhancement and built-in non-uniformity corrections (NUCs). The camera's digital output provides high quality 12-bit images for image processing or transmission. The camera's low-power, light weight, and small size characteristics enables for easy integration into the proposed surveillance systems that can be deployed in hand-held, mobile, or fixed modes. While FIG. 1 illustrates combined visible and SWIR detection system on each side of the road it is also possible for a single detection system on one side of the road may suffice under most scenarios thereby mitigating the cost. Another set of combined visible and SWIR detection are located along the centerline of the road with one pointing in the direction of the approaching vehicle while the other pointing in the direction of the departing vehicle to enable the vehicle to be viewed from the front and the rear. An appropriately mounted combined visible and SWIR detection system to take an image of the vehicle from the front would suffice to get a complete view. Also, due to the high back and head rest seats within vehicles the combined visible and SWIR detection system located to take images from the rear of the vehicle may not yield any additional benefit and hence a single detection system to view the vehicle from the front would suffice. An alternate embodiment may require only one combined visible and SWIR detection system positioned on one side of the road angled towards an approaching vehicle which will substantially reduce the installation and deployments costs as such as system can be mounted on road light fixtures or signs. The angular mounting of the combined visible and SWIR detection system for this embodiment allows for the imaging of the approaching vehicle from the front and the side with a single system. The combined visible and SWIR detection system is angled at greater than 0 degrees and less than 45 degrees perpendicular to the road and towards the approaching vehicle. The deployment angle of the combined visible and SWIR detection system is determined by experimental evaluation and also depends on device characteristics such as the image capture period of the combined visible and SWIR detection system and the maximum vehicle speed.

The road has embedded proximity detection sensors that are triggered by a passing vehicle. The distance of triggering device from the combined visible and SWIR detection systems is determined via experimental evaluation and depends on the image capture period of the combined visible and SWIR detection system and the maximum vehicle speed. A controller consisting of embedded computing hardware and operating system, and application software is located at a nearby location and is used to manage the combined visible and SWIR detection systems based on inputs from the embedded proximity detection system. Alternate detection systems such as radio frequency (RF) and optical ranging and proximity systems may also be used to detect a passing vehicle and send the notification to the controller that may be co-located with the detection system. The ranging system could be based on COTS solutions such as laser distance measurement systems. The combined visible and SWIR detection system that is perpendicular to the road is i) triggered to take discrete images when the vehicle crosses the ingress embedded proximity detection system and ii) triggered to stop taking discrete images when the vehicle crosses the egress embedded proximity detection system. Similarly, the combined visible and SWIR detection system that is in line with the road is i) triggered to take discrete images when vehicle crosses the ingress embedded proximity detection system to get a view of the vehicle front; and ii) triggered to stop taking discrete images when vehicle crosses the egress embedded proximity detection system to get a view of the vehicle rear.

Information from all detection systems associated with a given vehicle is transmitted to the controller. The controller includes frame grabber and algorithms and to perform image processing, based on COTS and OpenSource computer vision and image processing software, to detect number of occupants within a given vehicle. The controller combines frames from different views and combines them to provide one composite view for object classification and identification. Based on the configurable threshold criteria within the controller, number of occupants within a given vehicle and the vehicle identification information is transmitted to the backend computing and decision support system. Note that only the information associated with vehicles that meet the configurable threshold criteria are transmitted thereby minimizing the false positive notifications and also minimizes the communication requirements from the remote controller and the backend computing and decision support system.

The front end systems consisting of the controller, a single combined visible and SWIR detection system, and possibly an RF or optical ranging and proximity system can be co-located in a single device package forming the front-end integrated system. This combined front end system allows for it to be positioned angularly on one side of the road as a standalone unit for imaging approaching vehicles in a particular lane. Also the integrated system allows for the unit to be portable thus allowing for it to be repositioned at alternate locations along the road with minimal effort to maintain the element of uncertainty among potential violators. This ability to reposition the front end system at alternate locations along the road also allows for minimizing the number of units required along long stretches of the road while maintaining the element of surprise and therefore enabling greater capture of potential traffic infractions.

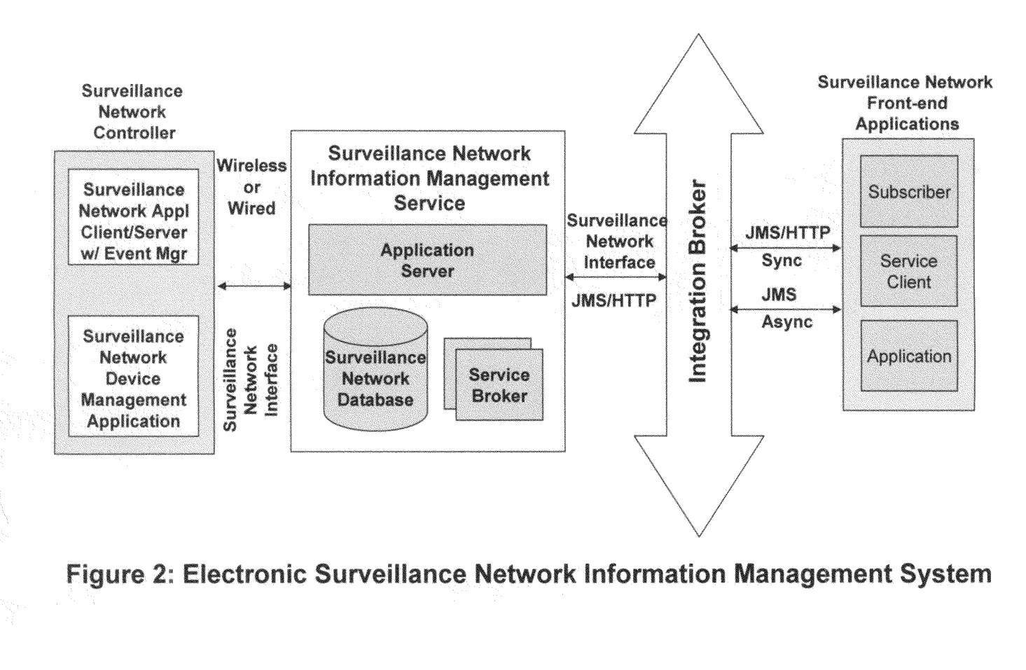

FIG. 2 illustrates the backend computing and decision support system for surveillance network information management system that includes Automatic License Plate Recognition (ALPR), e.g., http://www.platerecognition.info/ and http://www.platescan.com/, Information management (IM) system that includes Publisher/Subscriber (Pub/Sub) engine, e.g., Apache ActiveMQ, within a Service Oriented Architecture (SOA), as defined by The Open Group standards organization—http://opengroup.org/, to allow for the inclusion of value add services. Here, JMS stands for Java Message Service and HTTP stands for HyperText Transfer Protocol. The value add services include image recognition applications and graphical visualization console for law enforcement personnel to view the integrated composite images to confirm that the vehicle driver is in violation and initiate the issuance and mailing of violation ticket to the registered driver of the vehicle. Note that a single vehicle violating the traffic rules may be detected by multiple front end systems within a configured period of time that may include multiple roads. This implies that the backend system will receive multiple notification and information regarding the same violating vehicle from multiple sites. The law enforcement rules may limit the number of tickets given to the same vehicle within a pre-configured period and in this case the IM system will merge multiple violations into a single count based on the unique vehicle identification derived from the either the vehicle license plate or alternate vehicle identification number derived by the front end system and forwarded to the backend system. This mechanism allows for law enforcement to limit the number of traffic infraction tickets issued to a given vehicle within a pre-configured period.

In order to determine the number of occupants within a vehicle it is not necessary to perform precise image recognition. Additionally, for this application it is adequate to determine the number of human occupants within the vehicle and furthermore detailed image recognition is not warranted for privacy concerns. The image recognition application is there required to only determine the number of human occupants within the vehicle and hence should be primarily intended to discern human occupants from the rest and determine the count for the number of human occupants. The level of image resolution and processing & comparison against database templates for humans is minimal and at a coarse level. Therefore, image of vehicle occupants from the combined visible and SWIR detection system need only be compared against a few templates to determine the count for the number of human occupants within the particular vehicle. Human image recognition application can use various techniques such as Bayesian Decision Algorithms and Neural Networks. The IM System (IMS) interfaces with one or more of the image recognition applications and makes the decision based on the collective response from all the image recognition applications. The defined IMS provides an open and modular framework allowing for the integration of one or more image recognition application systems.

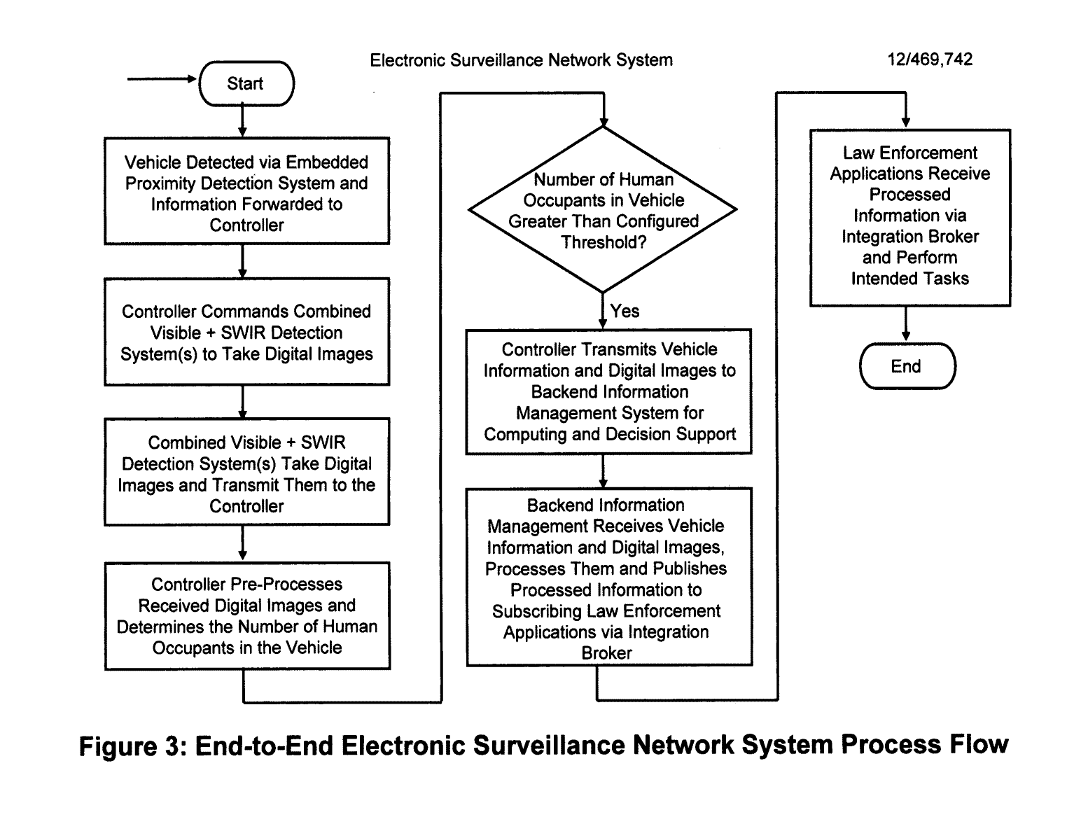

Integration broker couples an orchestration engine with flexible transformation and routing features to support multipoint application, process, service, and/or data integration with other heterogeneous subscribers, clients, and applications and the surveillance network information management server. The integration broker provides multipoint service orchestration, i.e., rule-driven flow of information, context, and control among diverse environments within distributed law enforcement entities. The integration broker also enables application-level transactional context and applies rules regarding content transformation, message routing, and process invocation. Integration brokers providing critical connection points in the shared communication bus that also provides transactional level reliability for data exchange between surveillance network information management server and various heterogeneous subscribers, clients, and applications. Finally, the integration broker greatly eases the coordination between surveillance information management server and the diverse applications, services, and other networked resources. Surveillance network front-end applications consist of law enforcement subscribers, service clients, and applications that provide heterogeneous systems access to the surveillance network information management system within the SOA Web Services environment. These surveillance network front-end applications include interconnectivity to service providers such as instant visualization and law enforcement database services. FIG. 3 summarizes the process flow for the end-to-end electronic surveillance network system.

What is claimed and desired secured by United States Letters Patent is:

1. Electronic surveillance network system architecture
System architecture that includes combined visual and SWIR detection system, embedded proximity detection system, controller, backend computing and decision support system, surveillance network information management server, integration broker, surveillance network front-end applications.

2. Use of combined visual and SWIR detection systems in claim 1 for the detection of number of occupants in a vehicle that is in operation day and night.

3. Use of a controller in claim 1 that manages the combined visual and SWIR detection systems based on inputs from the embedded proximity detection system in claim 1.

4. A controller algorithm in claim 3 to combine discrete images from visual and SWIR sources into an integrated image that provides a combined view.

5. A controller frame grabber and algorithms in claim 4 to perform image processing to detect number of occupants within a given vehicle based on configurable threshold criteria.

6. An algorithm and implementation to compute the speed of the approaching vehicle from captured images of multiple successive frames.

7. A surveillance network information management server in claim 1 for
Automatic License Plate Recognition (ALPR) Information management (IM) system and Publisher/Subscriber (Pub/Sub) engine within a Service Oriented Architecture (SOA) to allow for the inclusion of value add services; and open and modular framework allowing for the integration of one or more image recognition application systems.

8. An integration broker in claim 1 for the system to enable effective management and coordination across distributed and hierarchically configured surveillance information management servers.

9. An ability to keep track of repeat offenders by creating and keeping a watch list of prior offenders (vehicles) as can be discerned from the license plates of the cars detected and not from facial recognition of the drivers since this algorithm only counts the number of occupants and does not identify the drivers for privacy reasons (based on recent history).
